(19) United States
(12) Patent Application Publication
(10) Pub. No.: US 2003/0154490 A1
(43) Pub. Date: Aug. 14, 2003

(54) Broadcasting apparatus used in a computer system

(76) Inventor: Ming-Chih Chang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,944

(22) Filed: May 28, 2002

(30) Foreign Application Priority Data
Feb. 8, 2002 (TW) 091102549

(51) Int. Cl. H04N 7/173

(52) U.S. Cl. 725/105; 725/117; 725/131

(57) ABSTRACT

A broadcasting apparatus used in a computer system includes a receiver, a control circuit, an audio data stream controller, and a video data stream controller. The receiver is used to receive signals transmitted from a network. The control circuit is used to generate a broadcasting audio signal and a broadcasting video signal based on the signals transmitted from the receiver. The audio data stream controller is electrically connected to the control circuit and an audio device to generate a sound signal according to the broadcasting audio signal and an audio signal generated by the audio device, and to transmit the sound signal to a speaker. The video data controller is electrically connected to the control circuit and a video device to generate a graphic signal according to the broadcasting video signal and a video signal generated by the video device, and to transmit the graphic signal to a monitor.

### BACKGROUND OF INVENTION

1. Field of the Invention

The present invention relates to a broadcasting apparatus, and more particularly, to a broadcasting apparatus that can independently operate from a computer. The broadcasting apparatus receives broadcasting signals transmitted from a network and displays the message without processing by a central processing device of the computer.

2. Description of the Prior Art

In this modern information-based society, networks have provided convenient lives for users. For example, users can interchange digital data, technologies, and experiences through a network. Therefore, users can get data or knowledge quickly. Because of the convenience of networks, many companies have installed an internal LAN (local area network). All computers in the company are connected to the same LAN. Therefore, data can be interchanged inside the LAN fast, thereby increasing the efficiency of employees.

Please refer to FIG. 1. FIG. 1 is a perspective view of a prior art computer 10 in which the computer 10 is connected to a network 16. The computer 10 can connect to another computer 12 and a server 14 through the network 16. The prior art computer 10 comprises a central processing device 20, a hard disk 22E (or a flash memory or a CD-ROM drive) for storing non-volatile data, a memory 22D (such as random access memory) for temporarily storing volatile data, an input device 22F (such as keyboard, mouse) for inputting instructions or data, a graphics card 24A for processing graphics, a sound card 24B for processing sounds, a network interface card 24C for network connection, a monitor 30A for displaying images, and a speaker 30B for playing acoustic waves. The graphics card 24A is electrically connected to the monitor 30A through a connecting port 26A.The sound card 24B is electrically connected to the speaker 30B through a connecting port 26B. The network interface card 24C is electrically connected to the network 16 through a connecting port 26C (and through a network transmission line). The central processing device 20 comprises a CPU (central processing unit) 22A for processing data, a north bridge circuit 22B, and a south bridge circuit 22C. The central processing device 20 controls the operation of the computer 10. The CPU 22A exchanges data with the memory 22D, and transmits the image data to the graphics card 24A through north bridge circuit 22B. The graphics card 24A converts the image data into video signals 28A and then transmits the video signals 28A to the monitor 30A. The monitor 30A displays the video signals 28A so that users can watch the image corresponding to the video signal 28A. In addition, through the north bridge circuit 22B and the south bridge circuit 22C, the CPU 22A can receive the instruction transmitted from the input device 22F, access the data stored inside the hard disc 22E, and transmit the sound data to the sound card 24B. The sound card 24B converts the sound data into the corresponding audio signal 28B and then transmits the audio signal 28B to the speaker 30B. The speaker 30B converts the audio signal 28B into the acoustic wave so that users can hear the sound corresponding to the sound data.

The operation of the network interface card 24C can be illustrated as follows. In order to maintain the data transmission order inside the network, the network interface card of each computer comprises a different substantial address. The network interface card 24C has a substantial address ID. The network signal 28C, transmitted from the network 16 to the computer 10 in a package manner, is received by the network interface card 24C. This package includes not only the data transmitted to the computer 10, but also includes a destination address. When the package is transmitted to the computer 10, the destination address inside the package is set to be the same as the address ID of the network interface card 24C . After receiving the package, the network interface card 24C checks the destination address inside the package. If the destination address is the same as the address ID of the network interface card 24C, the network interface card 24C takes out the data inside the package. This data is communication data 28D. The communication data 28D is transmitted to the central processing device 20 through the south bridge circuit 22C. Therefore, the computer 10 can receive the data transmitted from the network 16. If the computer 10 wants to transmit data to the network 16, data is transmitted to the network interface card 24C through the south bridge circuit 22C . The network interface card 24C transforms the data into the package, and modulates the package into a network signal 28C . This network signal 28C is transmitted to the network 16 through the connecting port 26C .

In general, companies and users also use broadcasting to broadcast announcements such as notifications that break time is starting or ending, emerging announcements, important events, and so on. In prior art technology, these announcements must be broadcasted through speakers (each office has one or several speakers installed). This is inconvenient for users and the broadcasting can only transmit sound signals. Although some companies have LANs installed for transmitting sound and image data, there are still some difficulties in using the LAN to act as the broadcasting system according to the prior art. In the prior art computer 10, the data transmitted from the network 16 must be processed by the central processing device 20 first, then transmitted to the speaker 30B through the sound card 24B for playing, or transmitted to the monitor 30A through the graphics card 24A for displaying. However, the central processing device 20 must be used under a suitable operating system. The graphics card 24A and the sound card 24B must also be driven by suitable driving programs. If each computer connected to the network 16 has different operating systems and driving programs, a cross-platform data compatibility problem occurs. Therefore, the sound and image signals cannot be correctly decoded by some computers. In addition, when the central processing device 20 of the computer 10 is in a sleep status such as when the monitor 30A is running a screen saver, or when the computer 10 is crashed, the computer 10 cannot play the broadcast data transmitted from the network 16 in real-time. Therefore, users cannot get the broadcast data in time.

### SUMMARY OF INVENTION

It is therefore a primary objective of the claimed invention to provide a broadcasting apparatus that can independently operate from a computer. The broadcasting apparatus can perform broadcasting even if the central processing device has stopped operating so as to solve the defects of the prior art broadcasting apparatus.

The claimed invention, briefly summarized, discloses a broadcasting apparatus used in a computer system. The broadcasting apparatus comprises a receiver, a control circuit, an audio data stream controller, and a video data stream controller. The receiver is used to receive signals transmitted from a network. The control circuit is used to generate a broadcasting audio signal and a broadcasting video signal based on the signals received by the receiver. The audio data stream controller is electrically connected to the control circuit and an audio device to generate a sound signal according to the broadcasting audio signal and an audio signal generated by the audio device, and to transmit the sound signal to a speaker. The video data stream controller is electrically connected to the control circuit and a video device to generate a graphic signal according to the broadcasting video signal and a video signal generated by the video device , and to transmit the graphic signal to a monitor.

There are many advantage that the claimed invention broadcasting apparatus can directly use the LAN in the office without another wire, can broadcast the sound and image signals, can select the specific broadcasting object and range, does not need to be processed by the central processing device, and will not influence by the software and hardware configuration. Even if the computer has crashed, the broadcasting signal can still be broadcasted.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a prior art computer in which the computer is connected to a network.

FIG. 2 is a perspective view of a present invention broadcasting apparatus in which the broadcasting apparatus is used in a computer.

FIG. 3 is a perspective view of another embodiment of the present invention broadcasting apparatus in which the broadcasting apparatus is used in a computer.

### DETAILED DESCRIPTION

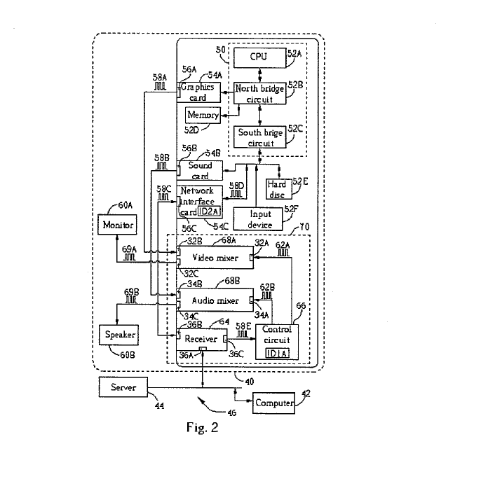

Please refer to FIG. 2. FIG. 2 is a perspective view of a present invention broadcasting apparatus 70 in which the broadcasting apparatus 70 is used in a computer 40. A server 44 is connected to a plurality of computers (terminals) through a network 46 (FIG. 2 only shows two computers 40, 42 as an example). The following illustrates an embodiment in which the broadcasting apparatus 70 is installed in the computer 40 so as to disclose the technology of the present invention. The computer 40 comprises a central processing device 50, a graphics card 54A, a memory 52D, a sound card 54B, a network interface card 54C, a hard disk 52E, an input device 52F, a monitor 60A, and a speaker 60B. The central processing device 50 includes a CPU (central processing unit) 52A, a north bridge circuit 52B, and a south bridge circuit 52C. The function of the above components is identical to the function of the same-named components inside the computer 10. The network interface card 54C includes a substantial address ID2A. The network interface card 54C receives a package network signal 58C through a connecting port 56C. The package network signal 58C has a destination address; if the destination address matches the address ID2A of the network interface card 54C, the network interface card 54C takes out the data inside the network signal 58C so as to produce communication data 58D (if the destination address does not match the address ID2A, the network interface card 54C discards the package network signal 58C). The communication data 58D is transmitted to the central processing device 50 so that the computer 40 can receive the data transmitted through the network 46. If the communication data 58D has image and sound data, the central processing device 50 transmits the sound data to the sound card 54B, and transmits the image data to the graphics card 54A. The sound card 54B transforms the sound data into the audio signal 58B and outputs the audio signal 58B through the connecting port 56B. The graphics card 54A transforms the image data into the video signal 58A and outputs the video signal 58A through the connecting port 56A.

The present invention broadcasting apparatus 70 comprises a receiver 64, a control circuit 66, a video mixer 68A as a video data steam controller, and an audio mixer 68B as an audio data stream controller. The receiver 64 has an input end 36A and two output ends 36B, 36C. The function of the receiver 64 is similar to a network hub. The input end 36A is connected to the network 46 (through the network transmission line). The two output ends 36B and 36C are respectively connected to the network interface card 54C and the control circuit 66. After receiving the package network signal through the network 46, the receiver 64 respectively outputs the package network signal through the two output ends 36B and 36C. Both the network interface card 54C and the control circuit 66 can receive the package network signal transmitted from the network 46. They are the package network signal 58C received by the network interface card 54C, and the package network signal 58E received by the control circuit 66. Similar to the network interface card 54C, the control circuit 66 has a substantial address ID1A which is different from the address ID2A. If the destination address inside the package network signal 58E matches the address ID1A of the control circuit 66, the control circuit 66 takes out the data inside the package network signal 58E. Otherwise, the control circuit 66 discards the package network signal 58E. After taking out the data inside the package network signal 58E, the control circuit 66 converts the data into the corresponding broadcasting video signal 62A and the broadcasting audio signal 62B.

The video mixer 68A and the audio mixer 68B of the broadcasting apparatus 70 respectively comprise input ends 32A, 32B, 34A, 34B, and output ends 32C, 34C. The input ends 32A and 32B of the video mixer 68A are respectively connected to the control circuit 66 and the graphics card 54A for receiving the broadcasting video signal 62A and the video signal 58A. The output end 32C of the video mixer 68A is electrically connected to the monitor 60A. The video mixer 68A mixes the broadcasting video signal 62A and the video signal 58A so as to form an graphic signal 69A. The graphic signal 69A is outputted to the monitor 60A through the output end 32C so that users can see the image corresponding to the video signal 58A and the broadcasting video signal 62A. The two input ends 34A and 34B of the audio mixer 68B respectively connect to the control circuit 66 and the sound card 54B for receiving the broadcasting audio signal 62B and the audio signal 58B. The audio mixer 68B mixes the broadcasting audio signal 62B and the audio signal 58B so as to form an sound signal 69B. The sound signal 69B is outputted to the speaker 60B through the output end 34C so that users can hear the acoustic waves corresponding to the audio signal 58B and the broadcasting audio signal 62B.

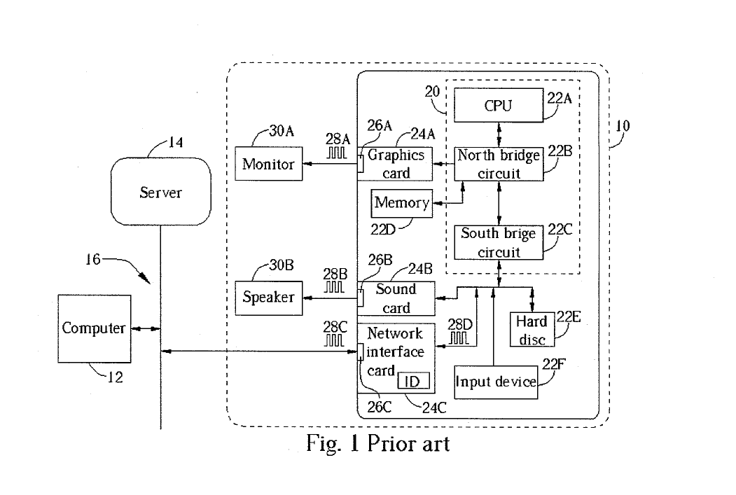

Compare the computer 40 of FIG. 2 to the prior art computer 10 of FIG. 1. In computer 10, the network signal 28C transmitted from the network 16 is received by the network interface card 24C. The monitor 30A and the speaker 30B are directly connected to the graphics card 24A and the sound card 24B, respectively. In computer 40, the computer 40 has a broadcasting apparatus 70 installed. The network signal transmitted from the network 46 is received by the receiver 64 of the broadcasting apparatus 70. The monitor 60A and the speaker 60B are respectively connected to the video mixer 68A and the audio mixer 68B of the broadcasting apparatus 70. That means the receiver 64 of the broadcasting apparatus 70 receives the network signal instead of the network interface card 54C. The graphics card 54A and the sound card 54B respectively output the signal to the video mixer 68A and the audio mixer 68B of the broadcasting apparatus 70 instead of outputting the signal to the monitor 60A and the speaker 60B.

The main purpose of the present invention is to use the LAN and the computers installed in general offices to perform the broadcasting, and the operation of the broadcasting system is not influenced by the software and hardware operation of the computer. This purpose can be fulfilled by installing the present invention broadcasting apparatus 70 inside the computer 40. The operation of the present invention can be illustrated as follows. As shown in FIG. 2, when the server 44 wants to broadcast an announcement to a user of the computer 40, the server 44 can set the destination address to be the address ID1A and transmit the broadcasting signal (including the audio signal and the video signal) to the network 46 in package network signal manner. After receiving the package network signal, the receiver 64 of the computer 40 transmits the package network signal to the control circuit 66 and the network interface card 54C. The control circuit 66 analyses the destination address inside the package network signal, and then takes out the broadcasting signal from the package network signal. The control circuit 66 converts the broadcasting signal into the corresponding broadcasting video signal 62A and the broadcast audio signal 62B according to the content of the broadcasting signal (if the broadcasting signal only has an image signal or a sound signal, the control circuit 66 only converts the image signal into the corresponding broadcasting video signal, or converts the sound signal into the corresponding broadcasting audio signal). The broadcasting video signal 62A and the broadcasting audio signal 62B are respectively transmitted to the video mixer 68A and the audio mixer 68B so as to mix with the video signal 58A and the audio signal 58B originally generated by the central processing device 50. The mixed graphic signal and the sound signal are transmitted to the monitor 60A and the speaker 60B for playing. Please notice that the broadcasting signal is directly processed by the control circuit 66, and does not need to be processed by the central processing device 50. The video signal and the audio signal of the broadcasting signal are simultaneously played with the video signal and audio signal generated by the central processing device 50. When the central processing device 50 crashes, the central processing device 50 is unable to control the graphics card 54A and the sound card 54B to generate the video signal and the audio signal. However, since the video mixer 68A and the audio mixer 68B of the broadcasting apparatus 70 is not controlled by the central processing device 50, the video mixer 68A and the audio mixer 68B respectively output the broadcasting video signal and broadcasting audio signal to the monitor 60A and the speaker 60B for playing, and are not influenced by the central processing device 50. Of course, the broadcasting signal is neither influenced by the operating system and the driving program so that there is no problem with cross-platform data compatibility.

On the other hand, the broadcasting apparatus 70 does not influence the normal operation of the computer 40. If the control circuit 66 has not received the package network signal for broadcasting, the control circuit 66 will not generate the broadcasting video signal 62A and the broadcasting audio signal 62B. At this time, the function of the video mixer 68A and the audio mixer 68B is to respectively transmit the video signal of the graphics card 54A and the audio signal of the sound card 54B to the monitor 60A and the speaker 60B. The monitor 60A and the speaker 60B still can play the image data and the sound data generated by the central processing device 50. The receiver 64 receives the package network signal from the network 46 and transmits it to the network interface card 54C. If the destination address of the package network signal matches the address ID2A, the network interface card 54C takes out the data inside the package network signal to form the communication data 58D. The communication data 58D is transmitted to the central processing device 50. When the central processing device 50 wants to send data to the network 46, the central processing device 50 can transmit the sending data to the network interface card 54C. The network interface card 54C forms the sending data into a package network signal. This package network signal is transmitted to the output end 36B of the receiver 64 through the connecting port 56C. The receiver 64 transmits the package network signal from the output end 36B to the input end 36A, and further transmits to the network 46. At this time, the output end 36B works like an input end, and the input end 36A works like an output end.

In actual practice, the broadcasting apparatus 70 can be made as an add-on card such as a PCI card that can be detachably installed inside the computer. The add-on card uses the same power source as the computer, but is not controlled by the central processing device. After installing the present invention broadcasting apparatus inside the computer, the server can transmit the broadcasting network signal to one or several specific computers according to the destination address (that means setting the destination addresses to be the same as the addresses of the control circuits of these computers) so as to control the broadcasting range. Of course, the server can determine whether to broadcast the sound signal only, the image signal only, or both of the signals.

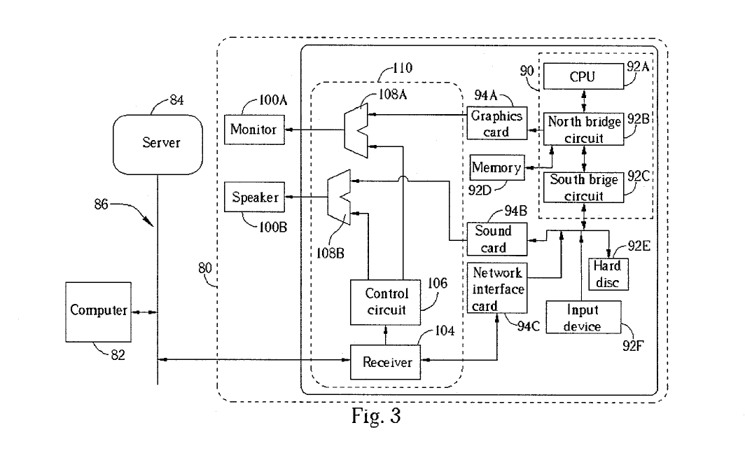

Please refer to FIG. 3. FIG. 3 is a perspective view of another embodiment of the present invention broadcasting apparatus 110 in which the broadcasting apparatus 110 is used in a computer 80. The network 86 is connected to a server 84 and two computers 80, 82. The computer 80 will be used as an example to illustrate the second embodiment of the present invention. Nowadays, many graphics cards and sound cards are installed on board motherboards of computers. Therefore, the present invention broadcasting apparatus also can be installed on board the motherboard and use the electrical power supplied by the motherboard. With the computer 80 shown in FIG. 3, the broadcasting apparatus 110 can be directly integrated inside the computer 80. The computer 80 comprises a central processing device 90, a memory 92D, a hard disc 92E, an input device 92F, a graphics card 94A, a sound card 94B, a network interface card 94C, the broadcasting apparatus 110, a monitor 100A, and a speaker 100B. The central processing device 90 has a CPU (central processing unit) 92A, a north bridge circuit 92B, and a south bridge circuit 92C. The broadcasting apparatus 10 includes a receiver 104, a control circuit 106, multiplexers 108B and 108A as an audio data steam controller and a video data stream controller, respectively.. The function of the above components is identical to the function of the same-named components of the first embodiment, except that the multiplexer 108B transmits only the audio signal to the speaker 100B when there is no broadcasting audio signal received, and the multiplexer 108B switches to transmit only the broadcasting audio signal to the speaker when it receives the broadcasting audio signal from the control circuit 106. Similarly, the multiplexer 108A transmits only the video signal from the graphics card 94A to the monitor 100A when there is no broadcasting video signal. Once the broadcasting video signal is generated by the control circuit 106, the multiplexer 108A switches to transmit only the broadcasting video signal to the monitor 100A. In such configuration, normal video signal (from the graphic card 94A) and audio signal (from the sound card 94B) are temporarily stopped respectively by the multiplexers 108A and 108B, such that only the broadcasting video and audio signals are presented to the user. After demonstrating the broadcasting video and audio signals, the multiplexers 108A and 108B restore to transmit normal video and audio signal to the monitor 100A and speaker 100B by switching back, respectively.

The prior art broadcasting system has many defects, such as the prior art broadcasting system must be connected by wires, installed speakers, and transmits sound signals only, or must processed by the central processing device so that the broadcasting signal is influenced by the hardware or software configuration, and so on. In contrast to the prior art broadcasting system, the present invention broadcasting apparatus and system can directly use an existing LAN in the office without another wire, can broadcast sound and image signals, can select the specific broadcasting object and range, does not need to be processed by the central processing device, neither influenced by the software and hardware configuration. Even if the computer crashes, the broadcasting signal also can be broadcasted.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A broadcasting apparatus used in a computer system, comprising:
a receiver for receiving signals transmitted from a network;
a control circuit for generating a broadcasting audio signal based on the signals transmitted from the receiver; and
an audio data stream controller electrically connected to the control circuit and an audio device for generating a sound signal according to the broadcasting audio signal and an audio signal generated by the audio device , and then transmitting the sound signal to a speaker.

2. The broadcasting apparatus of claim 1 wherein the audio data stream controller is a mixer for mixing the audio signal and the broadcasting audio signal to generate the sound signal.

3. The broadcasting apparatus of claim 1, wherein the audio data stream controller is a multiplexer, which generates the sound signal only according to the broadcasting audio signal while receiving the broadcasting audio signal from the control circuit, and generates the sound signal only according to the audio signal when the control circuit stop generating the broadcasting audio signal.

4. The broadcasting apparatus of claim 1, wherein the audio data stream controller generates the sound signal only according to the broadcasting audio signal when there is no audio signal transmitted to the audio data stream controller.

5. The broadcasting apparatus of claim 1, wherein the receiver is electrically connected to a network interface, and the receiver is capable of transmitting signals to the network interface and receiving signals transmitted from the network interface.

6. The broadcasting apparatus of claim 1, wherein the control circuit stores a first address for comparing with a destination address of the signal transmitted from the receiver, and generates the broadcasting audio signal corresponding to the signal transmitted from the receiver when the destination address is identical to the first address.

7. A broadcasting apparatus used in a computer system, comprising:
a receiver for receiving signals transmitted from a network;
a control circuit for generating a broadcasting video signal based on the signals transmitted from the receiver; and
a video data steam controller electrically connected to the control circuit and a video device for generating a graphic signal according to the broadcasting video signal and a video signal generated by the video device, and then transmitting the graphic signal to a monitor.

8. The broadcasting apparatus of claim 7, wherein the video data stream controller is a mixer for mixing the video signal and the broadcasting video signal to generate the graphic signal.

9. The broadcasting apparatus of claim 7, wherein the video data stream controller is a multiplexer, which generates the graphic signal only according to the broadcasting video signal while receiving the broadcasting video signal from the control circuit, and generates the graphic signal only according to the video signal when the control circuit stop generating the broadcasting video signal.

10. The broadcasting apparatus of claim 7, wherein the video data stream controller generates the graphic signal only according to the broadcasting video signal when there is no video signal transmitted to the video data stream controller.

11. The broadcasting apparatus of claim 7, wherein the receiver is electrically connected to a network interface, and the receiver is capable of transmitting signals to the network interface and receiving signals transmitted from the network interface.

12. The broadcasting apparatus of claim 7, wherein the control circuit stores a first address for comparing with a destination address of the signal transmitted from the receiver, and generates the broadcasting video signal corresponding to the signal transmitted from the receiver when the destination address is identical to the first address.

13. A broadcasting apparatus used in a computer system comprising:
a receiver for receiving signals transmitted from a network;
a control circuit for generating a broadcasting audio signal and a broadcasting video signal based on the signals transmitted from the receiver;
an audio data stream controller electrically connected to the control circuit and an audio device for generating a sound signal according to the broadcasting audio signal and an audio signal generated by the audio device, and transmitting the sound signal to a speaker; and
a video data stream controller electrically connected to the control circuit and a video device for generating a graphic signal according to the broadcasting video signal and a video signal generated by the video device, and then transmitting the graphic signal to a monitor.

14. The broadcasting apparatus of claim 13 wherein the receiver is electrically connected to a network interface, and the receiver is capable of transmitting signals to the network interface and receiving signals transmitted from the network interface.

15. The broadcasting apparatus of claim 13 wherein the control circuit stores a first address for comparing with a destination address of the signal transmitted from the receiver, and generates the broadcasting video signal and the broadcasting audio signal corresponding to the signal transmitted from the receiver when the destination address is identical to the first address.
